(19) United States
(12) Patent Application Publication
(10) Pub. No.: US 2017/0265036 A1
(43) Pub. Date: Sep. 14, 2017

(54) LOCATION BASED NOTIFICATION MANAGEMENT

(71) Applicant: INTERNATIONAL BUSINESS MACHINES CORPORATION, Armonk, NY (US)

(72) Inventor: Jeremy A. Greenberger, Raleigh, NC (US)

(21) Appl. No.: 15/064,124

(22) Filed: Mar. 8, 2016

(51) Int. Cl. H04W 4/02; H04W 4/06

(52) U.S. Cl. CPC H04W 4/023; H04W 4/06

(57) ABSTRACT

A method includes determining a first location for a user. Responsive to determining a notification procedure does not exist for the first location, the method sends a first notification to an electronic device associated with the user, wherein a type for the first notification is based on the first location. Responsive to determining the user has viewed the first notification, the method identifies a first set of parameters for the first notification, wherein the first set of parameters includes information pertaining to the first notification, the first location, and the electronic device associated with the user. The method creates a first notification procedure for the first location based at least on the first set of parameters, wherein the first notification procedure represents a user specific policy for sending notifications to the user at the first location. The method stores the first notification procedure with the first set of parameters.

### BACKGROUND

The present invention relates generally to electronic notifications and more particularly to managing notification procedures based on location for electronic devices.

Electronic device based notifications are a popular means of providing enhanced customer experiences for customers across various venues, such as stadiums, airports, retail stores, and hospitals. Electronic device based notifications can provide a variety of information to users from promotional to informative content. For example, a notification can include a hyperlink to a webpage or can include a barcode for obtaining discounts on promotional products. Typically, a user has the ability to specify whether the electronic device can receive notifications from various third party sources.

### SUMMARY

Embodiments of the present invention include a method, computer program product and computer system for managing virtual content during a collaborative event. A computer-implemented method includes determining, by one or more processors, a first location for a user; responsive to determining a notification procedure does not exist for the first location, sending, by one or more processors, a first notification to an electronic device associated with the user, wherein a type for the first notification is based on the first location; responsive to determining the user has viewed the first notification, identifying, by one or more processors, a first set of parameters for the first notification, wherein the first set of parameters includes information pertaining to the first notification, the first location, and the electronic device associated with the user; creating, by one or more processors, a first notification procedure for the first location based at least on the first set of parameters, wherein the first notification procedure represents a user specific policy for sending notifications to the user at the first location; and storing, by one or more processors, the first notification procedure with the first set of parameters.

### BRIEF DESCRIPTION OF THE DRAWINGS

FIG. 1 is a functional block diagram illustrating a distributed data processing environment, in an embodiment in accordance with the present invention.

FIG. 2A is a flowchart depicting one embodiment of a notification procedure manager establishing a procedure for notifying a user based on a particular location, in accordance with the present invention.

FIG. 2B is a flowchart depicting one embodiment of a notification procedure manager implementing and updating a procedure for notifying a user based on a particular location, in accordance with the present invention.

FIG. 3 illustrates an example scenario of a notification procedure manager implementing a notification procedure, in accordance with the present invention.

FIG. 4 illustrates an example scenario of a notification procedure manager creating a notification procedure, in accordance with the present invention.

FIG. 5 is a block diagram of components of a computer system, such as the computer server of FIG. 1, in an embodiment in accordance with the present invention.

### DETAILED DESCRIPTION

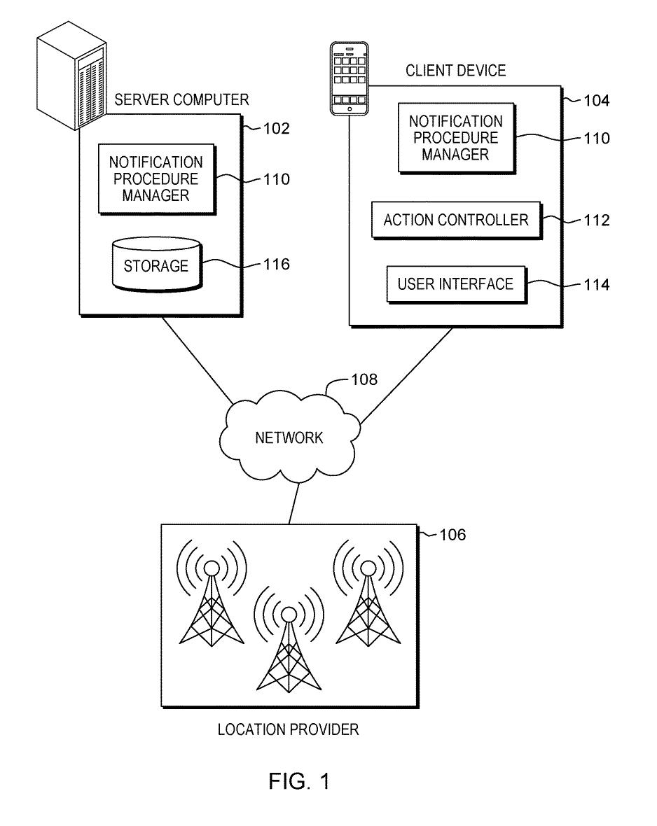

Example embodiments in accordance with the present invention will now be described in detail with reference to the drawing figures. FIG. 1 is a functional block diagram illustrating a distributed data processing environment. The distributed data processing environment includes server computer 102, client device 104, and location provider 106 interconnected over network 108.

Server computer 102 may be a desktop computer, a laptop computer, a tablet computer, a specialized computer server, a smartphone, or any other computer system known in the art. In certain embodiments, server computer 102 represents a computer system utilizing clustered computers and components that act as a single pool of seamless resources when accessed through network 108, as is common in data centers and with cloud computing applications. In general, server computer 102 is representative of any programmable electronic evice or combination of programmable electronic devices capable of executing machine-readable program instructions and communicating with other computer devices via a network. In this embodiment, server computer 102 includes notification procedure manager 110 and storage 116 accessible by client device 104 and any other electronic devices not illustrated in FIG. 1, via network 108.

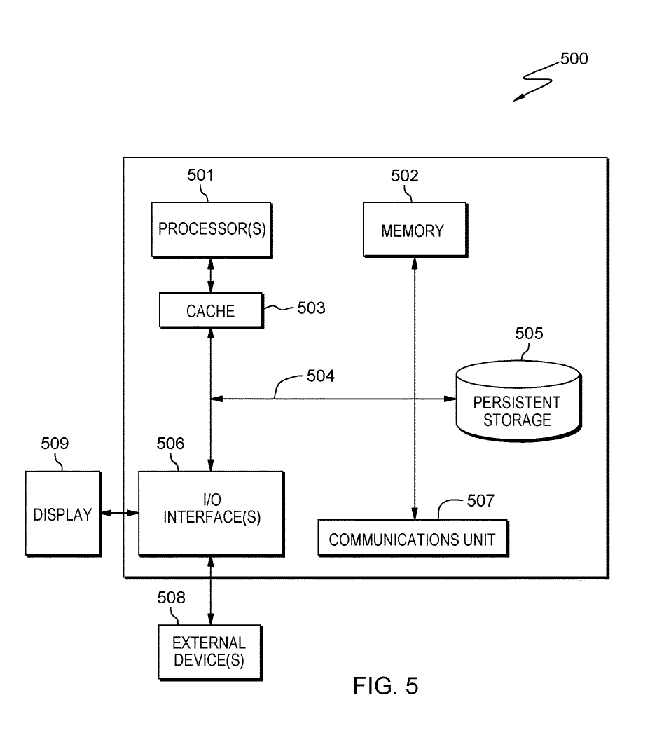

Client device 104 may be a laptop computer, tablet computer, netbook computer, personal computer (PC), personal digital assistant (PDA), smart phone, wearable device (e.g., smart watch, personal fitness device, personal safety device), onboard vehicle infotainment system, or any programmable computer system known in the art with an interactive display. Client device 104 includes notification procedure manager 110, action controller 112, and user interface 114. In general, client device 104 is representative of any programmable electronic device or combination of programmable electronic devices capable of executing machine-readable program instructions and communicating with users of other electronic devices via network 108. Client device 104 may include components, as depicted and described in further detail with respect to FIG. 5, in accordance with embodiments of the present invention.

In one embodiment, location provider 106 utilizes one or more positioning sensors capable of determining a location of client device 104 in a particular setting. For example, if a user walks into a store, location provider 106 determines a location of the store and particular aisle in which the user of client device 104 is located. In another embodiment, location provider 106 utilizes location triangulation technology available through a service provider for client device 104. Location provider 106 can identify location coordinates for client device 104 and send the location coordinates to notification procedure manager 110. Notification procedure manager 110 can receive the coordinates from location provider 106 and identify where the user of client device 104 is located in a particular location.

Notification procedure manager 110 can either operate in a client-side based setting, for example on client device 104, or notification procedure manager 110 can operate in a server-side based setting, for example on server computer 102. Notification procedure manager 110 has the ability to establish, implement, and update a procedure for notifying a user based on a particular location of a user of client device 104. A notification procedure represents a user specific policy for sending notifications to client device 104 associated with the user based on where the user is located. A particular location includes various measures of parameters which notification procedure manager 110 utilizes to establish a particular notification procedure for a user of client device 104. For example, a notification procedure for a user of client device 104 located in a museum can include high sensitivity parameters, where the notification procedure includes a policy with a reduced amount of notifications being sent to client device 104. In another example, a notification for a user of client device 104 located in a supermarket can include low sensitivity parameters, where the notification procedure includes a policy with a higher amount of targeted notifications being sent to client device 104.

Notification procedure manager 110 can determine a location for the user of client device 104 through location provider 106 and determine whether a notification procedure exists for the location where the user of client device 104 is located. In the event notification procedure manager 110 determines a notification procedure exists, notification procedure manager 110 can execute the notification procedure for client device 104. Upon determining parameters for the notification procedure have been altered, notification procedure manager 110 can update the notification procedures with the altered parameters and store the updated notification procedure.

In the event notification procedure manager 110 determines a notification procedure does not exist, notification procedure manager 110 can initialize the creation of a notification procedure by sending a notification to the user of client device 104 based on a location. Notification procedure manager 110 can determine whether the user of client device 104 viewed the notification and whether the user of client device 104 deleted the notification. Notification procedure manager 110 can identify parameters for the viewed or deleted notification, where the parameters allow for notification procedure manager 110 to create a notification procedure based on an analysis of the identified parameters. Notification procedure manager 110 can store the notification procedure and implement the notification procedure once the user of client device 104 returns to the location for which the notification procedure was originally created.

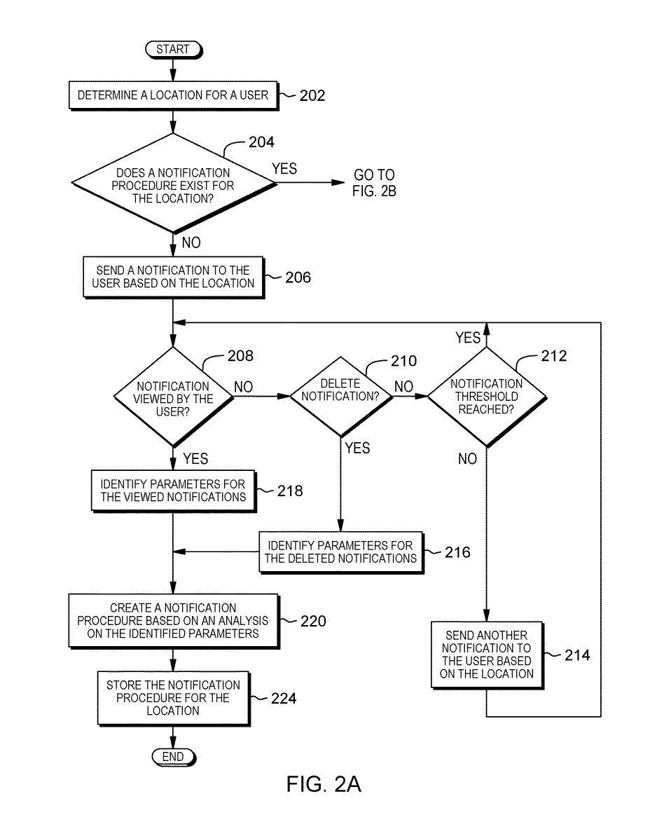

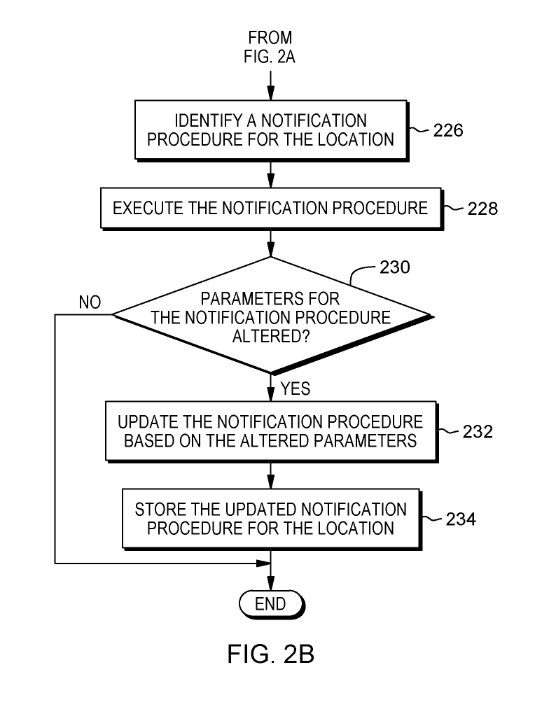

Action controller 112 can determine actions performed by a user of client device 104 and send the action information to notification procedure manager 110, where notification procedure manager 110 can translate the received action information into a parameter for establishing or updating a notification procedure. For example, action controller 112 determines that client device 104 was motioned in a manner to activate the screen and no further action was taken. In another example, action controller 112 determines that client device 104 received a user input to activate the screen and no further action was taken. Notification procedure manager 110 can receive the action information from action controller 112 and determine the user viewed a notification sent to client device 104 but did not take any action. Furthermore, notification procedure manager 110 determines the user of client device 104 reacted negatively to the received notification at this particular location and stores the negative reaction in the form of parameters for a notification procedure for the particular location. The ability of notification procedure manager 110 to identify and create parameters for the notification procedure is further discussed with regard to FIG. 2A.

Client device 104 also includes user interface (UI) 114 and various programs (not shown). Examples of the various programs on client device 104 include: a web browser, an e-mail client, security software (e.g., a firewall program, a geo-locating program, an encryption program, etc.), an instant messaging (IM) application (app), and a communication (e.g., phone) application. In an example, a user of client device 104 can interact with user interface 114, such as a touch screen (e.g., display) that performs both input to a graphical user interface (GUI) and as an output device (e.g., a display) presenting a plurality of icons associated with software applications or images depicting the executing software application. Optionally, a software application (e.g., a web browser) can generate user interface 114 operating within the GUI of client device 104. User interface 114 accepts input from a plurality of input/output (I/O) devices including, but not limited to, a tactile sensor interface (e.g., a touch screen, a touchpad) referred to as a multi-touch display. An I/O device interfacing with user interface 114 may be connected to client device 104, which may operate utilizing wired (e.g., USB port) or wireless network communications (e.g., infrared, NFC, etc.).

In general, network 108 can be any combination of connections and protocols that will support communications among server computer 102, client device 104, and location provider 106. Network 108 can include, for example, a local area network (LAN), a wide area network (WAN), such as the internet, a cellular network, or any combination of the preceding, and can further include wired, wireless, and/or fiber optic connections. In one embodiment, notification procedure manager 110 can be a web service accessible via network 108 to a user of client device 104. In another embodiment, notification procedure manager 110 may be operated directly by a user of server computer 102.

Storage 116 located on server computer 102, represents any type of storage device capable of storing data that is accessed and utilized by notification procedure manager 110. In other embodiments, storage 116 represents multiple storage devices within server computer 102. Storage 116 stores information such as, but not limited to, user information, account information, location information, notification procedures, and notification procedure parameters.

FIG. 2A is a flowchart depicting one embodiment of a notification procedure manager establishing a procedure for notifying a user based on a particular location, in accordance with the present invention. As depicted, a method includes determining (202) a location for a user, determining (204) whether a notification procedure exists, sending (206) a notification to the user based on the location, determining (208) whether the user viewed the notification, determining (210) whether to delete the notification, determining (212) whether the notification threshold has been reached, sending (214) another notification to the user based on the location, identifying (216) parameters for the deleted notification, identifying (218) parameters for the viewed notification, creating (220) a notification procedure based on an analysis on the identified parameters, and storing (224) the notification procedure for the location. In one embodiment, notification procedure manager 110 performs the above-mentioned steps of the method.

The method may commence by determining (202) a location for a user. In this embodiment, notification procedure manager 110 determines a location for a user of client device 102 based on information received from location provider 106. Notification procedure manager 110 receives location coordinates for the user of client device 104 and based on the received location coordinates, determines a location for the user in a particular setting. For example, notification procedure manager 110 determines a user is located in a parking lot of a shopping mall based on the coordinates received from location provider 106. In another embodiment, notification procedure manager 110 determines a location for a user when client device 104 connects to a local wireless Internet connection (i.e., Wi-Fi network). Notification procedure manager 110 has the ability to identify the public network based on the IP address and determine a location for the user of client device 104 based on the location of the identified public network. For example, if a user of client device 104 walks into supermarket ABC, client device 104 can automatically connect to the public Wi-Fi provided by the supermarket ABC. Upon establishing a connection, notification procedure manager 110 determines the user of client device 104 is located at supermarket ABC. In yet another embodiment, notification procedure manager 110 utilizes wireless beacon architecture to determine a location for client device 104.

The method may continue by determining (204) whether a notification procedure exists. In the event a notification procedure does not exist (“no” branch, 204), notification procedure manager 110 sends (206) a notification to the user based on the location to initiate the creation of a notification procedure based on the determined location for the user. In the event a notification procedure does exist (“yes” branch, 204), notification procedure manager 110 identifies (226) a notification procedure for the location. Implementation and updating of existing notification procedures is further discussed in FIG. 2B.

The method may continue by sending (206) a notification to the user based on the location. In this embodiment, notification procedure manager 110 sends a notification to the user of client device 104 based on a particular aisle of a supermarket in which the user is located. The notification can include targeted advertisement to the user based at least on the location of the user and the publicly available information about the user (e.g., age and home address). In one example, the user is located in a dairy section of a supermarket and notification procedure manager 110 determines to send a notification with information about a new brand the supermarket has partnered with. In another example, the user is located in the prepped food section of a supermarket and notification procedure manager 110 determines to send a notification with information containing a link to recipes for the prepped food being sold by the supermarket.

In another embodiment, notification procedure manager 110 sends a notification to the user based on a number of times the user has appeared at a particular location. For example, a user of client device 104 is driving on a city street looking for street parking in a particular location. While search for street parking, notification procedure manager 110 determines that the user of client device 104 has passed through the same location twice within a pre-determined time period (e.g., 5 minutes). Notification procedure manager 110 determines, based on the user of client device 104 appearing in a location multiple times in a pre-determined time period, the user of client device 104 is searching for parking. Notification procedure manager 110 sends a notification to client device 104 with addresses to the nearest parking garages, along with rate information.

The method may continue by determining (208) whether the user viewed the notification. In this embodiment, notification procedure manager 110 receives information from action controller 112 and determines whether the user of client device viewed the notification. In one example, action controller 112 determines the user has not reacted to the notification, wherein a reaction includes activating user interface 114 to view a pre-amble of the received notification in a pre-determined amount of time. The pre-amble of a notification includes at least a portion of the complete notification being displayed in user interface 114, where a user of client device 104 would have to take further action to view the complete notification. In another example, action controller 112 determines the user has activated user interface 114 to view a pre-amble of the received notification but has not taken any further action in viewing the complete notification in a pre-determined amount of time. In yet another example, action controller 112 determines the user has activated user interface 114 to view a pre-amble of the received notification and has taken further action to view the complete notification sent by notification procedure manager 110. Notification procedure manager 110 determines a user of client device 104 has viewed the notification when the user has activated user interface 114 to view a pre-amble of the received notification and has taken further action to view the complete notification.

In the event notification procedure manager 110 determines the user has not viewed the notification (“no” branch, 208), notification procedure manager 110 determines (210) whether to delete the notification. In the event notification procedure manager 110 determines the user has viewed the notification (“yes” branch, 208), notification procedure manager 110 identifies (218) parameters for the view notification.

The method may continue by determining (210) whether to delete the notification. In this embodiment, notification procedure manager 110 determines whether the user of client device 104 has activated user interface 114 to view the pre-amble of the notification and delete the notification prior to taking further action to view the complete notification. In one example, notification procedure manager 110 can utilize a pre-determined amount of time (e.g., 10 minutes) as a threshold for determining not to delete the notification. For example, notification procedure manager 110 determines not to delete the notification after 10 minutes of receiving no response from action controller 112, where the user of client device 104 has either not reacted to the notification or has activated user interface 114 to view a pre-amble of the received notification without taking further action in viewing the complete notification. Notification procedure manager 110 can determine to delete a notification after a user of client device 104 has viewed the pre-amble of the notification and the user has not taken action after the pre-determined amount of time because the user was not responsive to the content of the notification based on the pre-amble being displayed. Alternatively, notification procedure manager 110 can determine to not delete a notification if a user of client device has not viewed the pre-amble of the notification and has not taken action after the pre-determined amount of time because the user may have not heard the notification or was distracted from seeing the notification. In yet another embodiment, notification procedure manager 110 receives a user selection from client device 104 to delete the notification.

In the event notification procedure manager 110 determines not to delete the notification (“yes” branch, 210), notification procedure manager 110 determines (212) whether the notification threshold has been reached. In the event notification procedure manager 110 determines to delete the notification (“no” branch, 210), notification procedure manager 110 identifies (216) parameters for the deleted notification.

The method may continue by determining (212) whether the notification threshold has been reached. The notification threshold represents an amount of notifications that notification procedure manager 110 can send a user while the user is in a particular location. The notification threshold can vary from location to location. For example, a high sensitivity location, such as a museum, would have a lower notification threshold and a low sensitivity location, such as a supermarket, would have a higher notification threshold. Notification procedure manager 110 can include a list of predefined high sensitivity locations and low sensitivity locations, where based on the determined (202) location of the user, notification procedure manager 110 can identify the sensitivity of the location based on the list. The user of client device 104 has the ability to manual override the notification threshold for one or more locations based on user preference. Furthermore, the user of client device 104 can assign notification threshold values for all locations based on a time of day and day of the week.

In the event notification procedure manager 110 determines the notification threshold has not been reached (“no” branch, 212), notification procedure manager 110 sends (214) another notification to the user based on the location. In the event notification procedure manager 110 determines the notification threshold has been reached (“yes” branch, 212), notification procedure manager 110 determines (208) whether the user viewed the notification. Notification procedure manager 110 can continue such a procedural loop until the user of client device 104 views the notification or deletes the notification.

The method may continue by sending (214) another notification to the user based on the location. Notification procedure manager 110 sends another notification to the user, wherein the other notification is substantially different from the originally sent notification. Notification procedure manager 110 sends another notification to the user of client device 104 based on a particular aisle of a supermarket in which the user is located. Similar to the original notification, the other notification includes targeted advertisement to the user based at least on the location of the user and the publicly available information about the user (e.g., age and home address). From the previously mentioned example, a user is located in the dairy section of the supermarket and notification procedure manager 110 determines to send a notification with information about an existing brand rather than a new brand the supermarket has partnered with. Alternatively, notification procedure manager 110 can send a discount offer for the new brand the supermarket has partnered with rather than information about an existing brand.

In another embodiment, notification procedure manager 110 sends a variation of the originally sent notification. For example, notification procedure manager 110 sends a variation of the notification that includes the same content as the original message but activates an audible tone via action controller 112 to capture the attention of the user of client device 104. If the user of client device 104 is located at a sporting event, the user may not have been aware of the original notification sent by notification procedure manager 110. Notification procedure manager 110 can determine if the audible tone accompanying the notification causes the user of client device 104 to act on the notification.

The method may continue by identifying (216) parameters for the deleted notification. Notification procedure manager 110 has the ability to identify parameters for the deleted notification and analyze the identified parameters by drawing determinations from the identified parameters. In this embodiment, notification procedure manager 110 identifies the parameters for the deleted notification, where the user of client device 104 activated user interface 114 to view a pre-amble of the received notification and deleted the received notification without taking further action in viewing the complete notification. A first example of parameters includes a period of time between when notification procedure manager 110 sent the notification to the user and when notification procedure manager 110 determined to delete the notification sent to the user. Notification procedure manager 110 can utilizes a threshold time period value to split the period of time into two categories. If the period of time between when notification procedure manager 110 sent the notification to the user and when notification procedure manager 110 determined to delete the notification sent to the user falls within the first category (e.g., time period 0 to 30 seconds), notification procedure manager 110 determines the user of client device 104 was responsive in viewing the notification for the location but was not responsive to the content of the notification. Alternatively, if the period of time between when notification procedure manager 110 sent the notification to the user and when notification procedure manager 110 determined to delete the notification sent to the user falls within the second category (e.g., time period 30 seconds to 10 minutes), notification procedure manager 110 determines the user of client device 104 was not responsive in viewing the notification for the location and was not responsive to the content of the notification. The second category includes a period of time, where the period of time includes an upper time limit equal to the pre-determined amount of time notification procedure manager 110 utilizes as a threshold for determining not to delete the notification, previously discussed in (210).

A second example of parameters includes information about the content of the deleted notification and information on the location of the user. Notification procedure manager 110 identifies the type of content present in the deleted notification and determines the user of client device 104 was not responsive to the content of the notification. In one example, the user of client device 104 is in a particular aisle in a supermarket and receives a notification containing advertisement for a product located in the particular aisle. Because the user of client device 104 deleted the notification, notification procedure manager 110 determines to no longer send notifications to the user of client device 104, where the notification includes advertisement type content. In another example, the user of client device 104 is located near the checkout lanes in a supermarket and notification procedure manager 110 determines the user of client device 104 was not responsive to the content of the notification. Notification procedure manager 110 can identify the location of the user and the content of the deleted notification sent to the user.

The method may continue by identifying (218) parameters for the viewed notification. Notification procedure manager 110 has the ability to identify parameters for the viewed notification and analyze the identified parameters by drawing determinations from the identified parameters. In this embodiment, notification procedure manager 110 identifies the parameters for the notification, where the user of client device 104 activated user interface 114 to view a pre-amble of the received notification and took further action in viewing the complete notification. A first example of parameters includes a period of time between when notification procedure manager 110 sent the notification to the user and when notification procedure manager 110 determined the user viewed the notification. Notification procedure manager 110 can utilize a threshold time period value to split the period of time into two categories. If the period of time between when notification procedure manager 110 sent the notification to the user and when notification procedure manager 110 determined to view the notification sent to the user falls within the first category (e.g., time period 0 to 30 seconds), notification procedure manager 110 determines the user of client device 104 was responsive in viewing the notification for the location and was responsive to the content of the notification. Alternatively, if the period of time between when notification procedure manager 110 sent the notification to the user and when notification procedure manager 110 determined to view the notification sent to the user falls within the second category (e.g., time period 30 seconds to 10 minutes), notification procedure manager 110 determines the user of client device 104 was not responsive in viewing the notification for the location and was responsive to the content of the notification.

A second example of parameters includes information about the content notification and information on the location of the user. Notification procedure manager 110 identifies the type of content present in the viewed notification and determines the user of client device 104 was responsive to the content of the notification. In one example, the user of client device 104 is in a particular aisle in a supermarket and receives a notification containing discount offers for a product located in the particular aisle. Because the user of client device 104 viewed the notification, notification procedure manager 110 determines the user of client device 104 was responsive to notifications containing discount offers. In another example, the user of client device 104 is located near the checkout lanes in a supermarket and receives a notification containing information about club membership to the supermarket. Notification procedure manager 110 determines the user of client device 104 was responsive to the content of the notification and was responsive to the experience at the supermarket.

Notification procedure manager 110 has the ability to determine a first location where a user of client device 104 received the notification, a second location where the user of client device 104 became aware of the notification, and a third location where the user of client device 104 retrieved the notification (i.e., viewed the complete content of the notification). Notification procedure manager 110 can utilize the three locations as part of the parameters for creating a notification procedure. Additionally, notification procedure manager 110 can utilize the three locations to establish a path for the user of client device 104 in a particular venue. Notification procedure manager 110 can compile the established paths for multiple users in the particular venue to perform an overall analysis on a general relationship between the venue and the users.

The method may continue by creating (220) a notification procedure based on an analysis on the identified parameters. In this embodiment, notification procedure manager 110 establishes a notification procedure for the identified location based on the analysis on the identified parameters, where determinations were drawn from the identified parameters. In an example the parameters for a notification sent to client device 104 include a location of checkout lanes in a supermarket, where the user of client device 104 was responsive to viewing the notification and was responsive to the content of the notification. Furthermore, the content of the notification to which the user of client device 104 was responsive towards includes a notification containing club membership information for the supermarket. Notification procedure manager 110 creates a notification procedure for the user of client device 104 based on the parameters, where the notification procedure includes notification procedure manager 110 sending the user information pertaining to the club membership when the user is near the checkout lanes at the supermarket or any other type of content while at a particular location.

In another example, the parameters for a notification sent to client device 104 include a location of particular city street, where the user of client device 104 was responsive to viewing the notification and was responsive to the content of the notification. Furthermore, the content of the notification to which the user of client device 104 was responsive towards includes a notification containing a list of parking garages in the vicinity of the particular city street. Notification procedure manager 110 determines that the user was responsive to the notification containing a list of parking garages in the vicinity of the particular city street. As a result, notification procedure manager 110 creates a notification procedure for the user of client device 104 based on the parameters, where the notification procedure includes notification procedure manager 110 sending the user a list of parking garages when the user is on the particular city street.

In yet another example, the parameters for a notification sent to client device 104 includes a location of a particular aisle in a store, where the user of client device 104 viewed a pre-amble of the received notification and deleted the received notification without taking further action in viewing the complete notification. Furthermore, the content of the notification included an advertisement for a product located in the particular aisle in the store. Notification procedure manager 110 determines that the user was not responsive to advertisement type notifications for the particular aisle in the store. As a result, notification procedure manager 110 creates a notification procedure for the user of client device based on the parameters, where the notification procedure includes notification procedure manager 110 not sending the user advertisement type notification for the particular aisle in the store. Notification procedure manager 110 creates the notification procedures for the user of client device 104 and updates the notification procedures (discussed further in FIG. 2B), establishing a compilation of notification procedures best suited for the user of client device 104.

The method may continue by storing (224) the notification procedure for the location. In this embodiment, notification procedure manager 110 stores the notification procedure along with the identified parameters for the location in a repository, such as storage 116 on server computer 102. Notification procedure manager 110 stores notification procedures based on locations for each user and updates each notification procedure whenever the user re-visits a particular location.

FIG. 2B is a flowchart depicting one embodiment of a notification procedure manager implementing and updating a procedure for notifying a user based on a particular location, in accordance with the present invention. As depicted, a method includes identifying (226) a notification procedure for the location, executing (228) the notification procedure, determining (230) whether the parameters for the notification procedure were altered, updating (232) the notification procedure based on the altered parameters, and storing (234) the updated notification procedure for the location. In one embodiment, notification procedure manager 110 performs the above-mentioned steps of the method.

The method may commence by identifying (226) a notification procedure for the location. In this embodiment, notification procedure manager 110 queries storage 116 to obtain a notification procedure for the user of client device 104 for the determined location 202. For example, notification procedure manager 110 determines the user of client device 104 is located in a particular aisle in a supermarket and determines that a notification procedure entry exists for the particular aisle in the supermarket. Notification procedure manager 110 queries storage 116 for the notification procedure for the location (i.e., the particular aisle in the supermarket) and receives the notification procedures, along with the stored parameters for the notification procedure. Implementation of a notification procedure by notification procedure manager 110 can also take into account other measures of client device 104 including, but not limited to, a type of open applications, a battery level, a temporary local notification setting, an alert setting, and an orientation.

Notification procedure manager 110 can identify open (i.e., running) applications on client device 104, where a particular application running on client device 104 correlates to the notification procedure. For example, a user of client device 104 is located in a supermarket and has an application associated with the supermarket running on client device 104. Notification procedure manager 110 identifies the notification procedure based on the location of the user and the open application, where the notification procedure includes sending notifications through the application. Notification procedure manager 110 can query client device 104 to obtain battery level information and identify the notification procedure for the location based on the received battery level information. For example, if a battery level is below a particular threshold (e.g., 10 percent), notification procedure manager 110 identifies a notification procedure for the location that would conserve remaining battery level, where the notification procedure sends a limited amount of notifications to client device 104. If a battery level is above the particular threshold (e.g., 10 percent), notification procedure manager 110 identifies a notification procedure for the location that does not take into account the remaining battery level.

Notification procedure manager 110 can identify a notification procedure for the location based on a temporary local notification setting. The temporary local notification setting represents a notification setting on client device 104, where client device 104 filters notifications being sent to the user. For example, a temporary local notifications setting prevents client device 104 from notifying the users between the hours of 9 AM and 5 PM. Notification procedure manager 110 can query client device 104 to determine if a temporary local notification setting is active and identifies the notification procedure for the location based on the temporary local notification settings. Notification procedure manager 110 can identify a notification procedure for the location based on an alert setting for client device 104, where the alert setting includes but is not limited to an audible tone, a vibration, and activation of a screen. Notification procedure manager 110 can query client device 104 to determine an alert setting and identify a notification procedure based on the alert setting.

Notification procedure manager 110 can identify a notification procedure for the location based on an orientation of client device 104, where the orientation of client device 104 includes but is not limited to being screen surface up or screen surface down. For example, client device 104 is orientated screen surface down while on a tabletop. Notification procedure manager 110 identifies a notification procedure for the location based on the orientation of client device 104 being screen surface down, where the notification procedure includes an audible or vibrating alert. The orientation of client device 104 being screen surface down on a tabletop means that the user of client device 104 may not see a visual notification.

The method may continue by executing (228) the notification procedure. In this embodiment, notification procedure manager 110 executes the notification procedure according to the received parameters for the notification procedure. In an example, as a user of client device 104 approaches the checkout lanes at a supermarket, notification procedure manager 110 executes the existing notification procedure. The existing notification procedure includes notification procedure manager 110 sending a notification to client device 104 containing a weekly newsletter for club members of the supermarket. In another example, user with client device 104 is driving down a particular city street, where the user is visiting a family member again. Notification procedure manager 110 executes the notification procedure and sends a notification to client device 104 containing a list of parking garages in the vicinity of the particular city street.

The method may continue by determining (230) whether the parameters for the notification procedure were altered. For example, an existing notification procedure includes notification procedure manager 110 sending a notification to client device 104 containing a weekly newsletter for club members of the supermarket. Based on the previously stored parameters, the user of client device 104 typically views a pre-amble of the received notification containing the newsletter and takes further action to view the complete notification. However, for this instance, notification procedure manager 110 determines the user of client device 104 viewed the pre-amble of the received notification containing the newsletter but did not take further action to view the complete notification. Notification procedure manager 110 determines the user of client device 104 has departed from the notification procedure and determines the parameters for the notification procedure have been altered.

In the event notification procedure manager 110 determines that the parameters for the notification procedure were altered (“yes” branch, 230), notification procedure manager 110 updates (232) the notification procedures based on the altered parameters. In the event notification procedure manager 110 determines that the parameters for the notification procedure were not altered (“no” branch, 230), notification procedure manager 110 ceases operations until the user of client device 104 relocates to a different location.

The method may continue by updating (232) the notification procedure based on the altered parameters. In this embodiment, notification procedure manager 110 updates the notification procedure by associating the altered parameters with the originally identified parameters for the notification procedure. Notification procedure manager 110 has the ability replace the originally identified parameters with the altered parameters based on a parameter replacement policy. A parameter replacement policy can include a number of times an altered parameter occurs prior to replacing the original parameter with the altered parameter.

In an example, an existing notification procedure includes notification procedure manager 110 sending a notification to client device 104 containing a weekly newsletter for club members of the supermarket. Based on the previously stored parameters, the user of client device 104 typically views a pre-amble of the received notification containing the newsletter and takes further action to view the complete notification. However, for this instance, notification procedure manager 110 determines the user of client device 104 viewed the pre-amble of the received notification containing the newsletter but did not take further action to view the complete notification. The parameter replacement policy for the notification procedure requires that this instance occur a second time in order to replace the original parameters. Because this is a first instance, notification procedure manager 110 determines to associate the altered parameters with the notification procedure rather than replace the original parameters with the altered parameters.

The method may continue by storing (234) the updated notification procedure for the location. In this embodiment, notification procedure manager 110 stores the altered parameters with the notification procedure for the location, along with the originally stored parameters. In another embodiment, notification procedure manager 110 replaces the originally stored parameters with the altered parameters and stores the updated notification procedure for the location with the altered parameters.

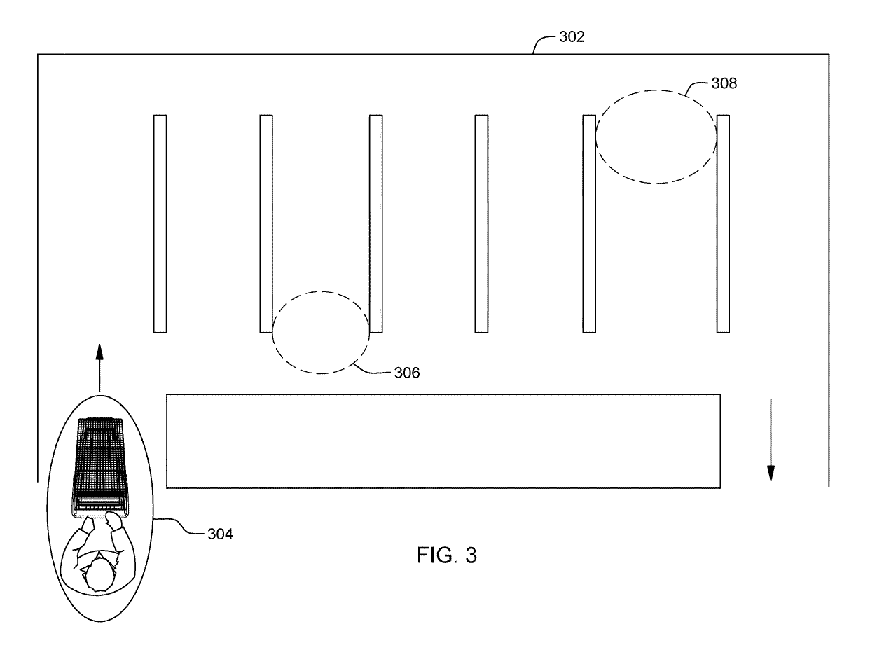

FIG. 3 illustrates an example scenario of a notification procedure manager implementing a notification procedure, in accordance with the present invention. In this example scenario, user 304 enters location 302, where location 302 is a supermarket. Notification procedure manager 110 receives location information from location provider 106 that user 302 is in the prepped food section of the supermarket, represented by area 306. Location 302 utilizes a public Wi-Fi network, where strategically placed Wi-Fi routers allow for location provider 106 to determine an area in location 302 where user 304 is located. Notification procedure manager 110 determines that a notification procedure exists for area 306 at location 302 for user 304 and identifies the notification procedure for area 306. Notification procedure manager 110 executes the notification procedure, where the notification procedure includes notification procedure manager 110 sending a notification to a client device of user 304 containing internet links to recipes for cooking the meal available in the prepped meal area (i.e., area 306). User 304 can view the notification in a user interface on the client device.

As user 304 moves through location 302, user 304 leaves the prepped meal area of the super market (i.e., area 306) and enters the frozen food section area of the supermarket, represented by area 308. Notification procedure manager 110 determines that a notification procedure exists for area 308 and identifies the notification procedure for area 308. Notification procedure manager 110 executes the notification procedure for area 308, where the notification procedure includes sending a notification to a client device of user 304 containing advertisements for products located in the frozen food section (i.e., area 308). Notification procedure manager 110 determines that user 304 has viewed the pre-amble of the notification but has deleted the notification prior to taking further action to view the complete notification. Notification procedure manager 110 determines that parameters for the notification procedure have been altered and updates the notification procedure based on the altered parameters. As a result, if user 304 enters area 308 in location 302 at a later time, notification procedure manager 110 executes the updated notification procedure. The updated notification procedure can include notification procedure manager 110 sending a notification containing a discount offer for a product in the frozen food section (i.e., area 308), rather than an advertisement for a product in the frozen food section.

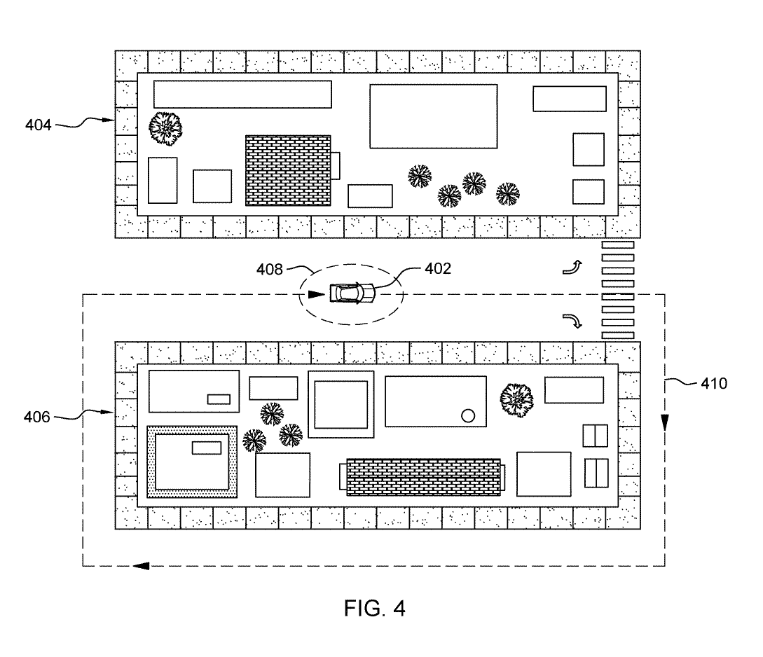

FIG. 4 illustrates an example scenario of a notification procedure manager creating a notification procedure, in accordance with the present invention. In this example scenario, user 402 is driving a vehicle on route 410, where route 410 represents driving on a street between block 404 and block 406 and completing a circle around block 406. The vehicle user 402 is driving utilizes a GPS navigational system capable of finding a location of the vehicle and sending the vehicle location to notification procedure manager 110. In this example scenario, notification procedure manager 110 determines that user 402 is looking for a parking spot based on route 410 provided by the GPS navigational system on the vehicle. Area 408 represents the point where notification procedure manager 110 determines a location for user 402. Subsequent to determining the location for user 402, notification procedure manager 110 determines that a notification procedure does not exist for user 402 while located in area 408.

Based on route 410, notification procedure manager 110 sends a notification to the vehicle user 402 is driving, where the notification includes a list of the nearest parking garages. A user interface in the vehicle can display the notification to user 402 and notification procedure manager 110 can determine whether user 402 has viewed the notification within a predetermined period of time. Upon notification procedure manager 110 determining that user 402 has viewed the notification, notification procedure manager 110 identifies the parameters for the viewed notification. In this example, the parameters can include a location for user 402 (i.e., area 408), the circle path taken by user 402 (i.e., route 410), and a response time for how quickly user 402 viewed the notification containing the list of the nearest parking garages. Notification procedure manager 110 creates a notification procedure based on an analysis on the identified parameters for area 408 and stores the notification procedure as a new entry in storage 116.

FIG. 5 depicts computer system 500, where server computer 102 and client device 104 are each an example of a system that includes notification procedure manager 110. The computer system includes processors 501, cache 503, memory 502, persistent storage 505, communications unit 507, input/output (I/O) interface(s) 506 and communications fabric 504. Communications fabric 504 provides communications between cache 503, memory 502, persistent storage 505, communications unit 507, and input/output (I/O) interface(s) 506. Communications fabric 504 can be implemented with any architecture designed for passing data and/or control information between processors (such as microprocessors, communications and network processors, etc.), system memory, peripheral devices, and any other hardware components within a system. For example, communications fabric 504 can be implemented with one or more buses or a crossbar switch.

Memory 502 and persistent storage 505 are computer readable storage media. In this embodiment, memory 502 includes random access memory (RAM). In general, memory 502 can include any suitable volatile or non-volatile computer readable storage media. Cache 503 is a fast memory that enhances the performance of processors 501 by holding recently accessed data, and data near recently accessed data, from memory 502.

Program instructions and data used to practice embodiments of the present invention may be stored in persistent storage 505 and in memory 502 for execution by one or more of the respective processors 501 via cache 503. In an embodiment, persistent storage 505 includes a magnetic hard disk drive. Alternatively, or in addition to a magnetic hard disk drive, persistent storage 505 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 505 may also be removable. For example, a removable hard drive may be used for persistent storage 505. Other examples include optical and magnetic disks, thumb drives, and smart cards that are inserted into a drive for transfer onto another computer readable storage medium that is also part of persistent storage 505.

Communications unit 507, in these examples, provides for communications with other data processing systems or devices. In these examples, communications unit 507 includes one or more network interface cards. Communications unit 507 may provide communications through the use of either or both physical and wireless communications links. Program instructions and data used to practice embodiments of the present invention may be downloaded to persistent storage 505 through communications unit 507.

I/O interface(s) 506 allows for input and output of data with other devices that may be connected to each computer system. For example, I/O interface 506 may provide a connection to external devices 508 such as a keyboard, keypad, a touch screen, and/or some other suitable input device. External devices 508 can also include portable computer readable storage media such as, for example, thumb drives, portable optical or magnetic disks, and memory cards. Software and data used to practice embodiments of the present invention can be stored on such portable computer readable storage media and can be loaded onto persistent storage 505 via I/O interface(s) 506. I/O interface(s) 506 also connect to display 509.

Display 509 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
sending, by one or more processors, a first notification to an electronic device associated with a user, wherein a type for the first notification is based on a first location;
responsive to determining the user has viewed the first notification, identifying, by one or more processors, a first set of parameters for the first notification, wherein the first set of parameters includes information pertaining to the first notification, the first location, and notification settings for the electronic device associated with the user;
creating, by one or more processors, a first notification procedure associated with the user for the first location based at least on the first set of parameters, wherein the first notification procedure associated with the user represents a user specific policy for sending notifications to the user at the first location;
storing, by one or more processors, the first notification procedure associated with the user, along with the first set of parameters; and
responsive to determining that at least one parameter from the first set of parameters has been altered, updating, by one or more processors, the first notification procedure associated with the user based on the at least one parameter from the first set of parameters.

2. The method of claim 1, further comprising:
determining, by one or more processors, a second location for the user; and
responsive to determining a notification procedure does exist for the second location, executing, by one or more processors, a second notification procedure for the second location based at least on a second set of parameters, wherein the second notification procedure represents a user specific policy for sending notifications to the user at the second location and the second set of parameters includes information pertaining to a previous notification, the second location, and the electronic device associated with the user.

3. The method of claim 2, further comprising:
responsive to determining at least one parameter out of the second set of parameters has been altered, wherein at least a portion of the information pertaining to the previous notification, the second location, and the electronic device associated with the user has changed, determining, by one or more processors, to replace the second set of parameters with a third set of parameters, wherein the third set of parameters is based on the second set of parameters with the at least one altered parameter; and
storing, by one or more processors, the second notification procedure with the third set of parameters.

4. The method of claim 1, wherein the parameters include a period of time until a notification is viewed, a location for the user, a notification type, and a notification indicator type.

5. The method of claim 1, further comprising:
determining, by one or more processors, a second location for the user;
responsive to determining a notification procedure does not exist for the second location, sending, by one or more processors, a second notification to the electronic device associated with the user, wherein a type of the second notification is based on the second location;
determining, by one or more processors, the user has viewed a pre-amble of the second notification, wherein the pre-amble of the second notification includes a portion of the second notification; and
responsive to determining a threshold amount of notifications sent to the electronic device has not been exceeded, sending, by one or more processors, a third notification to the electronic device associated with the user, wherein a type of the third notification is based on the second location and the type of the second notification.

6. The method of claim 1, wherein determining a first location for a user comprises: determining, by one or more processors, a first instance of the user at a particular location;
determining, by one or more processors, a second instance of the user at the particular location, wherein a period of time between the first instance and the second instance is below a threshold amount of time; and
identifying, by one or more processors, the particular location as the first location for the user.

7. The method of claim 1, further comprising:
determining, by one or more processors, a second location for the user;
responsive to determining a notification procedure does not exist for the second location, sending, by one or more processors, a second notification to the electronic device associated with the user, wherein a type of the second notification is based on the second location;
determining, by one or more processors, the user has viewed a pre-amble of the second notification, wherein the pre-amble of the second notification includes a portion of the second notification;
responsive to determining to delete the second notification, identifying, by one or more processors, a second set of parameters for the second notification, wherein the second set of parameters includes information pertaining to the second notification, the second location, and the electronic device associated with the user; and
creating, by one or more processors, a second notification procedure for the second location based at least on the second set of parameters, wherein the second notification procedure represents a user specific policy for sending notifications to the user at the second location.

8. A computer program product comprising:
one or more computer readable tangible storage media and program instructions stored on at least one of the one or more storage media, the program instructions comprising:
send a first notification to an electronic device associated with a user, wherein a type for the first notification is based on a first location;
program instructions to, responsive to determining the user has viewed the first notification, identify a first set of parameters for the first notification, wherein the first set of parameters includes information pertaining to the first notification, the first location, and notification settings for the electronic device associated with the user;
program instructions to create a first notification procedure associated with the user for the first location based at least on the first set of parameters, wherein the first notification procedure associated with the user represents a user specific policy for sending notifications to the user at the first location;
program instructions to store the first notification procedure associated with the user, along with the first set of parameters; and
responsive to determining that at least one parameter from the first set of parameters has been altered, updating, by one or more processors, the first notification procedure associated with the user based on the at least one parameter from the first set of parameters.

9. The computer program product of claim 8, further comprising program instructions, stored on the one or more computer readable storage media, which when executed by a processor, cause the processor to:
determine a second location for the user; and
responsive to determining a notification procedure does exist for the second location, execute a second notification procedure for the second location based at least on a second set of parameters, wherein the second notification procedure represents a user specific policy for sending notifications to the user at the second location and the second set of parameters includes information pertaining to a previous notification, the second location, and the electronic device associated with the user.

10. The computer program product of claim 9, further comprising program instructions, stored on the one or more computer readable storage media, which when executed by a processor, cause the processor to:
responsive to determining at least one parameter out of the second set of parameters has been altered, wherein at least a portion of the information pertaining to the previous notification, the second location, and the electronic device associated with the user has changed, determine to replace the second set of parameters with a third set of parameters, wherein the third set of parameters is based on the second set of parameters with the at least one altered parameter; and
store the second notification procedure with the third set of parameters.

11. The computer program product of claim 8, wherein the parameters include a period of time until a notification is viewed, a location for the user, a notification type, and a notification indicator type.

12. The computer program product of claim 8, further comprising program instructions, stored on the one or more computer readable storage media, which when executed by a processor, cause the processor to:
determine a second location for the user;
responsive to determining a notification procedure does not exist for the second location, send a second notification to the electronic device associated with the user, wherein a type of the second notification is based on the second location;
determine the user has viewed a pre-amble of the second notification, wherein the pre-amble of the second notification includes a portion of the second notification; and
responsive to determining a threshold amount of notifications sent to the electronic device has not been exceeded, send a third notification to the electronic device associated with the user, wherein a type of the third notification is based on the second location and the type of the second notification.

13. The computer program product of claim 8, wherein determining a first location for a user comprises program instructions, stored on the one or more computer readable storage media, which when executed by a processor, cause the processor to:
determine a first instance of the user at a particular location;
determine a second instance of the user at the particular location, wherein a period of time between the first instance and the second instance is below a threshold amount of time; and
identify the particular location as the first location for the user.

14. The computer program product of claim 8, further comprising program instructions, stored on the one or more computer readable storage media, which when executed by a processor, cause the processor to:
determine a second location for the user;
responsive to determining a notification procedure does not exist for the second location, send a second notification to the electronic device associated with the user, wherein a type of the second notification is based on the second location;
determine the user has viewed a pre-amble of the second notification, wherein the pre-amble of the second notification includes a portion of the second notification;
responsive to determining to delete the second notification, identify a second set of parameters for the second notification, wherein the second set of parameters includes information pertaining to the second notification, the second location, and the electronic device associated with the user; and
create a second notification procedure for the second location based at least on the second set of parameters, wherein the second notification procedure represents a user specific policy for sending notifications to the user at the second location.

15. A computer system comprising:
one or more computer processors;
one or more computer readable storage media; and
program instructions stored on the computer readable storage media for execution by at least one of the one or more computer processors, the program instructions comprising:
send a first notification to an electronic device associated with a user, wherein a type for the first notification is based on a first location;
program instructions to, responsive to determining the user has viewed the first notification, identify a first set of parameters for the first notification, wherein the first set of parameters includes information pertaining to the first notification, the first location, and notification settings for the electronic device associated with the user;
program instructions to create a first notification procedure associated with the user for the first location based at least on the first set of parameters, wherein the first notification procedure associated with the user represents a user specific policy for sending notifications to the user at the first location;
program instructions to store the first notification procedure associated with the user, along with the first set of parameters; and
responsive to determining that at least one parameter from the first set of parameters has been altered, updating, by one or more processors, the first notification procedure associated with the user based on the at least one parameter from the first set of parameters.

16. The computer system of claim 15, further comprising program instructions, stored on the one or more computer readable storage media, which when executed by a processor, cause the processor to:
determine a second location for the user; and
responsive to determining a notification procedure does exist for the second location, execute a second notification procedure for the second location based at least on a second set of parameters, wherein the second notification procedure represents a user specific policy for sending notifications to the user at the second location and the second set of parameters includes information pertaining to a previous notification, the second location, and the electronic device associated with the user.

17. The computer system of claim 16, further comprising program instructions, stored on the one or more computer readable storage media, which when executed by a processor, cause the processor to:
responsive to determining at least one parameter out of the second set of parameters has been altered, wherein at least a portion of the information pertaining to the previous notification, the second location, and the electronic device associated with the user has changed, determine to replace the second set of parameters with a third set of parameters, wherein the third set of parameters is based on the second set of parameters with the at least one altered parameter; and
store the second notification procedure with the third set of parameters.

18. The computer system of claim 15, wherein the parameters include a period of time until a notification is viewed, a location for the user, a notification type, and a notification indicator type.

19. The computer system of claim 15, further comprising program instructions, stored on the one or more computer readable storage media, which when executed by a processor, cause the processor to:
determine a second location for the user;
responsive to determining a notification procedure does not exist for the second location, send a second notification to the electronic device associated with the user, wherein a type of the second notification is based on the second location;
determine the user has viewed a pre-amble of the second notification, wherein the pre-amble of the second notification includes a portion of the second notification; and
responsive to determining a threshold amount of notifications sent to the electronic device has not been exceeded, send a third notification to the electronic device associated with the user, wherein a type of the third notification is based on the second location and the type of the second notification.

20. The computer system of claim 15, wherein determining a first location for a user comprises program instructions, stored on the one or more computer readable storage media, which when executed by a processor, cause the processor to:
determine a first instance of the user at a particular location;
determine a second instance of the user at the particular location, wherein a period of time between the first instance and the second instance is below a threshold amount of time; and
identify the particular location as the first location for the user.
